(19) United States
(12) Patent Application Publication
(10) Pub. No.: US 2020/0189083 A1
(43) Pub. Date: Jun. 18, 2020

(54) STAPLE GUN

(71) Applicant: APEX MFG. CO., LTD., Taichung City (TW)

(72) Inventors: Chih-Wei HU, Taichung City (TW); Jing-Li WANG, Taichung City (TW)

(21) Appl. No.: 16/221,969

(22) Filed: Dec. 17, 2018

(51) Int. Cl. B25C 5/16; B25C 5/11; B25C 5/02

(52) U.S. Cl. CPC B25C 5/1617; B25C 5/0285; B25C 5/11

(57) ABSTRACT

A staple gun is provided, including: a main body, including a bottom side, and a staple outlet and a notch disposed on the bottom side; a staple magazine, being withdrawably received within the main body, including a track portion and an abutting portion out of the track portion; a lock mechanism, being located at the bottom side, including a pressed member disposed on the main body and located within the notch, the pressed member having a blocking portion movable between a blocking position and a releasing position; wherein when the blocking portion is in the blocking position, the blocking portion is blockably connected with the abutting portion and the staple magazine is non-withdrawable from the main body; when the blocking portion is in the releasing position, the blocking portion is unlocked by the abutting portion and the staple magazine is withdrawable from the main body.

### BACKGROUND OF THE INVENTION

### Field of the Invention

The present invention relates to a staple gun.

### Description of the Prior Art

A conventional staple gun includes a main body and a staple magazine disposed on a bottom side of the main body, the staple magazine is lockable, by a lock mechanism, with an interior of the main body, and the lock mechanism includes an operation member which can be operated to unlock the staple magazine to allow withdrawal of the staple magazine from the main body. However, for the conventional staple gun, the staples are loaded from the bottom side, the press direction of the operation member of the lock mechanism is opposite to the staple-loading direction (bottom up), such that when the staples are loaded, mis-installation of the staples can occur often. Additionally, the conventional staple gun further includes an elastic member disposed between the main body and the staple magazine, for pushing the staples. As a result, when the lock mechanism is released, the staple magazine ejects strongly and quickly from the main body, it can cause injury to the user staple magazine or damage to the staple gun.

The present invention is, therefore, arisen to obviate or at least mitigate the above-mentioned disadvantages.

### SUMMARY OF THE INVENTION

The main object of the present invention is to provide a staple gun, which can avoid mis-installation of staples.

To achieve the above and other objects, the present invention provides a staple gun, including: a main body, including a bottom side, and a staple outlet and a notch the bottom side; a staple magazine, being withdrawably received within the main body, including a track portion configured to receive staples and an abutting portion which is located out of the track portion; a lock mechanism, being located at the bottom side, including a pressed member which is disposed on the main body and located within the notch, the pressed member having a blocking portion which is movable between a blocking position and a releasing position; wherein when the blocking portion is in the blocking position, the blocking portion is blockably connected with the abutting portion and the staple magazine is non-withdrawable from the main body; when the blocking portion is in the releasing position, the blocking portion is unlocked by the abutting portion and the staple magazine is withdrawable from the main body.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a breakdown drawing of the first preferable embodiment of the present invention;

FIG. 3 is a partial enlarged drawing of the first preferable embodiment of the present invention;

FIGS. 4 and 5 are drawings showing operation of the first preferable embodiment of the present invention; and

FIGS. 6 and 7 are drawings showing operation of a second preferable embodiment of the present invention.

### DETAILED DESCRIPTION OF THE PREFERRED EMBODIMENTS

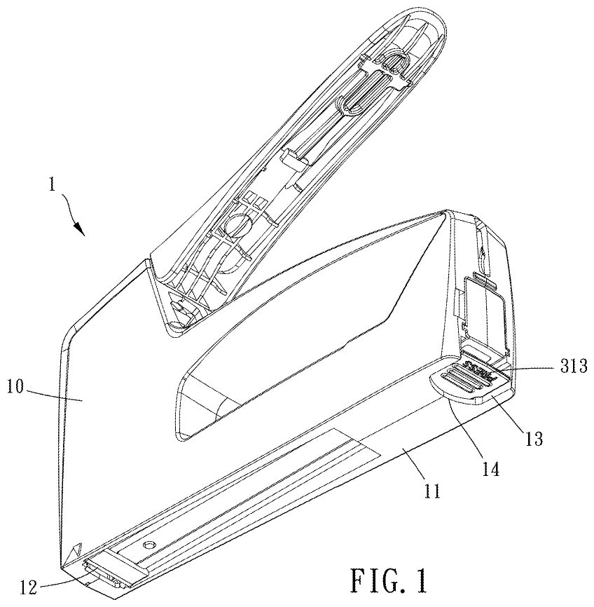

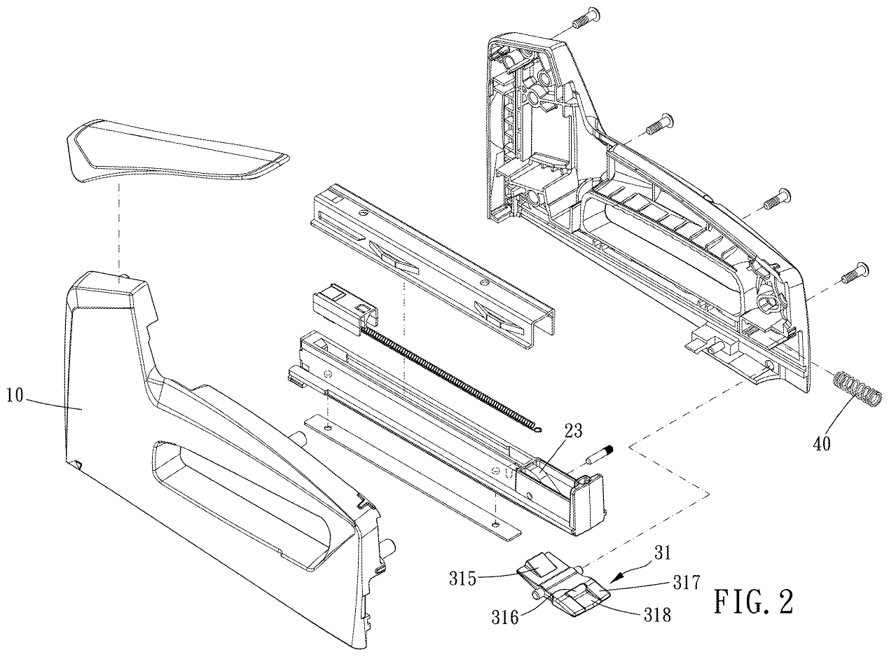

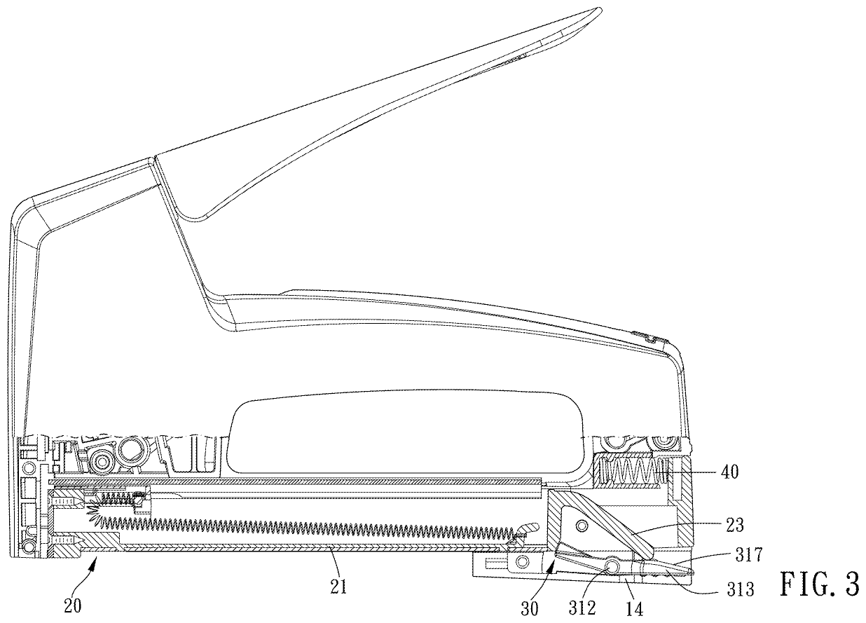

Please refer to FIGS. 1 to 5 for a first preferable embodiment of the present invention. A staple gun 1 of the present invention includes a main body 10, a staple magazine 20 and a lock mechanism 30.

The main body 10 includes a bottom side 11, and a staple outlet 12 and a notch 13 which are disposed on the bottom side 11; the staple magazine 20 is withdrawably received within the main body 10, and the staple magazine 20 includes a track portion 21 for mounting of staples and an abutting portion 22 which is located out of the track portion 21; the lock mechanism 30 is located at the bottom side 11 and includes a pressed member 31 which is disposed on the main body 10 and located within the notch 13, the pressed member 31 includes a blocking portion 311, and the blocking portion 311 which is movable between a blocking position and a releasing position between; wherein, when the blocking portion 311 is located in the blocking position, the blocking portion 311 is blockably connected with the abutting portion 22 and the staple magazine 20 is non-withdrawable from the main body 10; when the blocking portion 311 is located in the releasing position, the blocking portion 311 is unlocked by the abutting portion 22 and the staple magazine 20 is withdrawable from the main body 10. Whereby, the lock mechanism 30 is naturally operated with the bottom side 11 facing upward to withdraw the staple magazine 20, and it ensures that the staples can always be accurately loaded in right direction.

The pressed member 31 is rotatably attached to the main body 10, the abutting portion 22 includes an inclined face 221 facing toward a pivot point 312 of the pressed member 31, and the blocking portion 311 extends toward the staple magazine 20 and is configured to be stably abutted against the inclined face 221. However, the pressed member may be connected with the main body by other different ways; the abutting portion may be a convex face, concave face or the like. The pressed member 31 is rotatable from the notch 13 toward an interior of the main body 10. The pressed member 31 includes a push member 313 exposed from the notch 13 and an arm 314 extending into the bottom side 11, the push member 313 and the arm 314 extend oppositely from the pivot point 312 of the pressed member 31, and the push member 313 and the arm 314 are swingable in opposite directions at two opposite sides of the pivot point 312. The arm 314 is preferably integrally formed with a projection 315, and the projection 315 includes the blocking portion 311, thus having good structural strength and being capable of stably abutting against the abutting portion 22. However, the projection may not be integrally formed on the arm. The push member 313 and the arm 314 bend from the pivot point 312 toward the main body 10 so that the arm 314 and the bottom side 11 can provide efficient space therebetween for swinging. The push member 313 is preferably non-protrusive beyond the notch 13, thus avoiding misoperation.

The notch 13 disposed on the bottom side 11 is open in a direction away from the staple outlet 12, and thus the push member 313 can be pressed without obstacle. Preferably, the bottom side 11 includes a lip 14 defining the notch 13, the pivot point 312 of the pressed member 31 is located beside an inner side of the lip 14. When the blocking portion 311 is located in the blocking position, the push member 313 is abutted outwardly against the lip 14 so that the pressed member 31 cannot overswing and the blocking portion 311 can precisely abut against the abutting portion 22.

In this embodiment, the staple magazine 20 further includes an elastic arm 23, and the elastic arm 23 outwardly biases the pressed member 31 so that the blocking portion 311 is normally in the blocking position. The elastic arm 23 extends integrally from the staple magazine 20, which has good structural strength. However, the elastic arm may be additionally connected to the staple magazine. The pressed member 31 further includes a blocking protrusion 316 protruding toward the interior of the main body 10. When the blocking portion 311 is located in the blocking position, the elastic arm 23 is blocked with the blocking protrusion 316, which is uneasy to disengage. The pressed member 31 further includes a slant tail 317 extending slantingly outwardly from the blocking protrusion 316, thus ensuring that the push member 313 is swingable toward the interior of the main body 10. Preferably, the pressed member 31 further includes a recess 318 adjacent to the blocking protrusion 316, wherein the recess 318 is disposed on the slant tail 317 and extends in a direction away from the blocking portion 311. When the pressed member 31 swings toward the interior of the main body 10, the elastic arm 23 is disengaged from the blocking protrusion 316 and slides along the recess 318 so that the staple magazine 20 can smoothly withdraw from the main body 10.

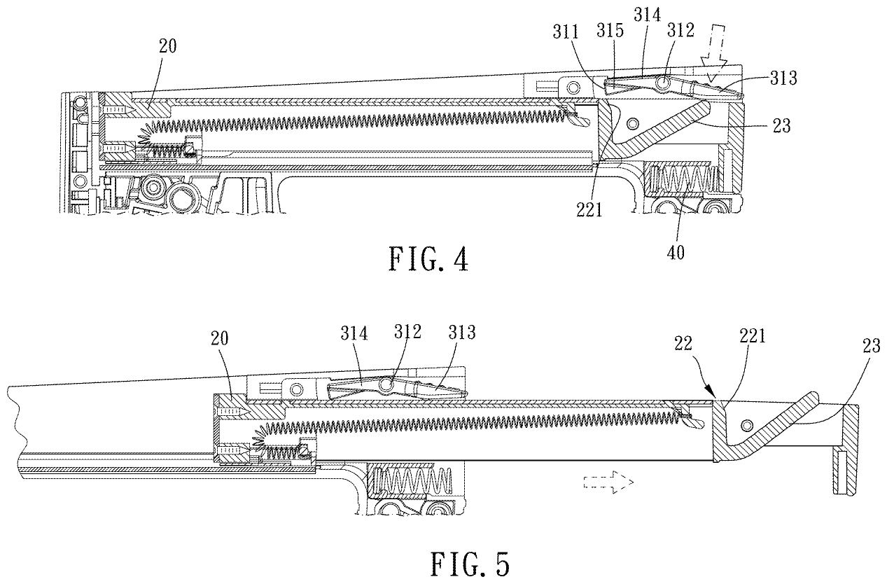

The staple gun 1 may further include an elastic member 40 disposed between the main body 10 and the staple magazine 20, and the elastic member 40 biases the staple magazine 20 in a direction away from the staple outlet 12. Whereby, when the blocking portion 311 moves to the releasing position, the staple magazine 20 can withdraw, by the elastic member 40, from the main body 10 (as shown in FIG. 4 and).

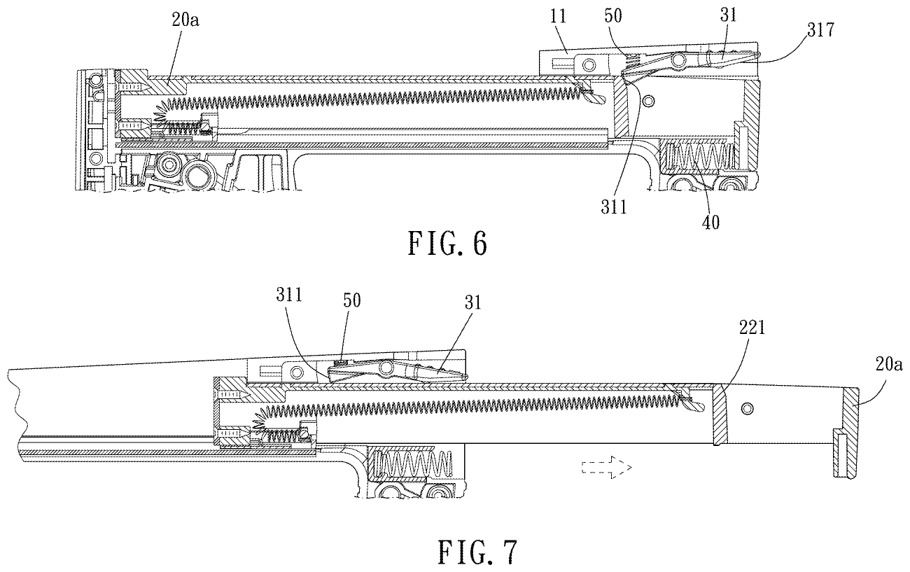

Please refer to FIGS. 6 and 7 for a second preferable embodiment of the present invention. In the second preferable embodiment, the staple magazine 20a does not include the elastic arm, and the staple gun further includes an elastic member 50 disposed between an inner side of the bottom side 11 and the pressed member 31 so that the blocking portion 311 is normally located in the blocking position. The elastic member 50 may be a coil spring or a sheet spring. The elastic member may be disposed between other position inside the main body and the pressed member.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A staple gun, including:
a main body, including a bottom side, and a staple outlet and a notch the bottom side;
a staple magazine, being withdrawably received within the main body, including a track portion configured to receive staples and an abutting portion which is located out of the track portion;
a lock mechanism, being located at the bottom side, including a pressed member which is disposed on the main body and located within the notch, the pressed member having a blocking portion which is movable between a blocking position and a releasing position;
wherein when the blocking portion is in the blocking position, the blocking portion is blockably connected with the abutting portion and the staple magazine is non-withdrawable from the main body; when the blocking portion is in the releasing position, the blocking portion is unlocked by the abutting portion and the staple magazine is withdrawable from the main body.

2. The staple gun of claim 1, wherein the pressed member is rotatably attached to the main body, the abutting portion includes an inclined face facing toward a pivot point of the pressed member, and the blocking portion extends toward the staple magazine.

3. The staple gun of claim 1, wherein the pressed member is rotatably attached to the main body and rotatable from the notch toward an interior of the main body, the pressed member includes a push member exposed from the notch and an arm extending into the bottom side, and the push member and the arm extend oppositely from a pivot point of the pressed member.

4. The staple gun of claim 3, wherein the push member and the arm bend from the pivot point toward the interior of the main body.

5. The staple gun of claim 3, wherein the bottom side includes a lip defining the notch, the pivot point of the pressed member is located beside an inner side of the lip, and when the blocking portion is located in the blocking position, the push member is abutted outwardly against the lip.

6. The staple gun of claim 3, wherein the arm is integrally formed with a projection, and the projection includes the blocking portion.

7. The staple gun of claim 1, wherein the staple magazine further includes an elastic arm, and the elastic arm outwardly biases the pressed member.

8. The staple gun of claim 7, wherein the pressed member further includes a blocking protrusion protruding toward an interior of the main body, and when the blocking portion is located in the blocking position, the elastic arm is blocked with the blocking protrusion.

9. The staple gun of claim 1, wherein the notch disposed on the bottom side is open in a direction away from the staple outlet.

10. The staple gun of claim 1, further including an elastic member disposed between the main body and the staple magazine, the elastic member biasing the staple magazine in a direction away from the staple outlet.

11. The staple gun of claim 1, further including an elastic member disposed between an inner side of the bottom side and the pressed member so that the blocking portion is normally located in the blocking position.

12. The staple gun of claim 5, wherein the abutting portion includes an inclined face facing toward a pivot point of the pressed member, and the blocking portion extends toward the staple magazine; the push member and the arm bend from the pivot point toward the interior of the main body; the arm is integrally formed with a projection, and the projection includes the blocking portion; the staple magazine further includes an elastic arm, and the elastic arm outwardly biases the pressed member; the elastic arm integrally extends from the staple magazine; the pressed member further includes a blocking protrusion protruding toward an interior of the main body, and when the blocking portion is located in the blocking position, the elastic arm is blocked with the blocking protrusion; the pressed member further includes a slant tail extending slantingly outwardly from the blocking protrusion; the pressed member further includes a recess adjacent to the blocking protrusion, the recess is disposed on the slant tail and extends in a direction away from the blocking portion; the notch disposed on the bottom side is open in a direction away from the staple outlet.
